(19) United States
(12) Patent Application Publication
(10) Pub. No.: US 2025/0178655 A1
(43) Pub. Date: Jun. 5, 2025

(54) POWERED WAREHOUSE CARTS AND METHODS OF USING THE SAME

(71) Applicant: DEFINITIVE TECHNOLOGY GROUP, LLC, Wilmington, DE (US)

(72) Inventors: David Sevigny, Wilmington, MA (US); Calvin Ting, Seattle, WA (US); Stephen Shaheen, Wilmington, MA (US)

(21) Appl. No.: 18/710,859

(22) PCT Filed: Jan. 16, 2024
(86) PCT No.: PCT/US24/11588

§ 371 Date: May 16, 2024

Related U.S. Application Data
(60) Provisional application No. 63/445,801, filed on Feb. 15, 2023.
(60) Provisional application No. 63/439,436, filed on Jan. 17, 2023.

(51) Int. Cl. B62B 3/00; B62B 5/00

(52) U.S. Cl. CPC B62B 3/005; B62B 5/0033; B62B 2203/10

(57) ABSTRACT

Powered warehouse carts and methods of using the same. The present disclosure includes disclosure of a warehouse cart, comprising a cart body having a bottom, a first side, an opposite second side, and a back, a first shelf coupled to a shelf lift mechanism coupled to or positioned relative to the cart body, and a battery is configured to provide power to the shelf lift mechanism to move the first shelf up and down.

### PRIORITY AND RELATED APPLICATIONS

The present application is related to, and claims the priority benefit of, a) U.S. Provisional Patent Application Ser. No. 63/445,801, filed Feb. 15, 2023, and b) U.S. Provisional Patent Application Ser. No. 63/439,436, filed Jan. 17, 2023, the contents of each application are incorporated herein directly and by reference in their entirety.

### BACKGROUND

Material handling carts (carts) are used to move items from one location to another, such as items located within warehouse bins, bags, totes, or other storage containers (collectively referred to as “bins”). Said carts are configured to hold multiple warehouse bins or storage containers, including those that may be stacked higher than they should be related to ergonomic and safety concerns given the weight and height of said bins. Injuries are common within warehouses and material handling facilities due to falling or hard to move items, such as warehouse bins, especially when a bin is too heavy for a person to safely place or remove to/from a high location.

As such, a warehouse cart configured to receive and move multiple bins, including bins at a high height that are safely positioned at said height, would be well received in the marketplace.

### BRIEF SUMMARY

The present disclosure includes disclosure of a warehouse cart, as shown and/or described herein.

The present disclosure includes disclosure of a warehouse cart, comprising of a cart body having a bottom, a first side, an opposite second side, and a back, a shelf coupled to a shelf lift mechanism, a powered wheel coupled to the cart body, and a battery dock configured to receive a battery therein, wherein the battery is configured to provide power to the shelf lift mechanism, to the powered wheel and any electronic peripherals or sensors that may be included in said cart not limited to displays, computing devices and sensors.

The present disclosure includes disclosure of a method for moving warehouse bins using a cart, as shown and/or described herein.

The present disclosure includes disclosure of a warehouse cart, comprising a cart body having a bottom, a first side, an opposite second side, and a back, a first shelf coupled to a shelf lift mechanism coupled to or positioned relative to the cart body, and a battery is configured to provide power to the shelf lift mechanism to move the first shelf up and down.

The present disclosure includes disclosure of a warehouse cart, further comprising a powered wheel coupled to the cart body, the powered wheel having a motor or having a motor coupled thereto.

The present disclosure includes disclosure of a warehouse cart, wherein the battery is configured to provide power to the motor to operate the powered wheel to facilitate powered movement of the cart.

The present disclosure includes disclosure of a warehouse cart, wherein when the cart is initially pushed or pulled in a first direction, the powered wheel operates to assist movement of the cart, and wherein when the cart is then pushed or pulled in an opposite, second direction, the powered wheel stops operating.

The present disclosure includes disclosure of a warehouse cart, wherein the powered wheel has a slope resistance configuration so that the cart will not accelerate downhill when the powered wheel is in operation.

The present disclosure includes disclosure of a warehouse cart, further comprising one or more passive wheels or casters coupled to the cart body.

The present disclosure includes disclosure of a warehouse cart, further comprising one or more shelf controls configured to control movement of the first shelf up and down.

The present disclosure includes disclosure of a warehouse cart, wherein one or more warehouse bins can be positioned upon the first shelf and be moved up and down with the first shelf by way of the shelf lift mechanism.

The present disclosure includes disclosure of a warehouse cart, further comprising a battery dock configured to retain the battery.

The present disclosure includes disclosure of a warehouse cart, wherein when the battery has a depleted charge, the battery can be removed from the dock and be replaced with a charged second battery.

The present disclosure includes disclosure of a warehouse cart, wherein the battery can be charged using external AC power.

The present disclosure includes disclosure of a warehouse cart, further comprising proximity sensors configured so that the cart can avoid obstacles while it is being moved.

The present disclosure includes disclosure of a warehouse cart, wherein the first shelf is configured to move to a lowest position that is above a warehouse bin positioned upon the bottom of the cart body.

The present disclosure includes disclosure of a warehouse cart, wherein the first shelf is configured to move to a lowest position that is above two stacked warehouse bins positioned upon the bottom of the cart body.

The present disclosure includes disclosure of a warehouse cart, wherein when an additional warehouse bin is positioned upon the first shelf, the first shelf can operate to move upward, creating a space below the first shelf and above the two stacked warehouse bins so that a third bin can be stacked upon the two stacked warehouse bins.

The present disclosure includes disclosure of a warehouse cart, further comprising a first scale positioned upon the first shelf, the first scale configured to weigh one or more items positioned thereupon.

The present disclosure includes disclosure of a warehouse cart, further comprising a second shelf positioned above the first shelf, the second shelf coupled to the shelf lift mechanism, wherein the shelf lift mechanism can be operated to move the second shelf up and down.

The present disclosure includes disclosure of a warehouse cart, further comprising a first scale positioned upon the first shelf, the first scale configured to weigh one or more items positioned thereupon, and a second scale positioned upon the first shelf, the second scale configured to weigh one or more items positioned thereupon.

The present disclosure includes disclosure of a warehouse cart, further comprising a third shelf positioned below the first shelf, the second shelf coupled to the shelf lift mechanism, wherein the shelf lift mechanism can be operated to move the third shelf up and down.

The present disclosure includes disclosure of a warehouse cart, further comprising a first scale positioned upon the first shelf, the first scale configured to weigh one or more items positioned thereupon, a second scale positioned upon the first shelf, the second scale configured to weigh one or more items positioned thereupon, and a third scale positioned upon the third shelf, the third scale configured to weigh one or more items positioned thereupon.

The present disclosure includes disclosure of a warehouse cart, further comprising a second shelf coupled to a second shelf lift mechanism, wherein the second shelf lift mechanism can operate to move the second shelf independent of movement of the first shelf.

The present disclosure includes disclosure of a warehouse cart, further comprising a first scale positioned upon the first shelf, the first scale configured to weigh one or more items positioned thereupon, and a second scale positioned upon the first shelf, the second scale configured to weigh one or more items positioned thereupon.

The present disclosure includes disclosure of a warehouse cart, further comprising a third shelf coupled to a third shelf lift mechanism, wherein the third shelf lift mechanism can operate to move the third shelf independent of movement of the first shelf and the second shelf.

The present disclosure includes disclosure of a warehouse cart, further comprising a first scale positioned upon the first shelf, the first scale configured to weigh one or more items positioned thereupon, a second scale positioned upon the first shelf, the second scale configured to weigh one or more items positioned thereupon, and a third scale positioned upon the third shelf, the third scale configured to weigh one or more items positioned thereupon.

The present disclosure includes disclosure of a warehouse cart, further comprising a powered wheel coupled to the cart body, a motor coupled to the powered wheel, and a central processing unit operably coupled to the motor and configured to instruct the motor to operate the powered wheel to move the cart.

The present disclosure includes disclosure of a warehouse cart, further comprising a location mechanism coupled to the central processing unit, the location mechanism configured to facilitate movement of the cart to a desired location.

The present disclosure includes disclosure of a warehouse cart, further comprising a shroud configured to be positioned relative to the first shelf and configured to prevent a user from injuring their hand or fingers while the first shelf moves up and down.

The present disclosure includes disclosure of a warehouse cart, further comprising a cart controller configured to direct movement of the cart when operated by a user.

The present disclosure includes disclosure of a warehouse cart, assembled by providing a kit to an existing cart, the kit comprising the first shelf, the shelf lift mechanism, and the battery, and assembling the warehouse cart by coupling elements of the kit to the cart.

The present disclosure includes disclosure of a warehouse cart, further comprising a second shelf, the second shelf movable up and down using the shelf lift mechanism or a second shelf lift mechanism.

The present disclosure includes disclosure of a warehouse cart, assembled by providing a kit to an existing cart, the kit comprising the first shelf, the shelf lift mechanism, the second shelf, the second shelf lift mechanism, and the battery, and assembling the warehouse cart by coupling elements of the kit to the cart.

The present disclosure includes disclosure of a warehouse cart, further comprising a sensor positioned relative to the first shelf, the sensor configured to alert a user to an obstacle above or below the shelf when the first shelf is moving up or down.

The present disclosure includes disclosure of a method of using a warehouse cart, comprising the steps of placing one or more bins upon the first shelf of a warehouse cart of the present disclosure, operating the shelf lift mechanism to lift the first shelf to an upper position, and placing one or more additional bins upon the bottom of the cart body of the warehouse cart.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a photograph of a warehouse cart, according to an exemplary embodiment of the present disclosure;

FIG. 2 shows a front view of a warehouse cart having warehouse bins stacked below the powered shelf, according to an exemplary embodiment of the present disclosure;

FIG. 3 shows the warehouse cart of FIG. 2 with warehouse bins positioned upon said shelf, according to an exemplary embodiment of the present disclosure;

FIG. 4 shows the warehouse cart of FIG. 2 with the shelf raised, according to an exemplary embodiment of the present disclosure;

FIG. 5 shows the warehouse cart of FIG. 2 with additional warehouse bins stacked upon the original bins, according to an exemplary embodiment of the present disclosure;

FIG. 6 shows the warehouse cart of FIG. 2 with the additional warehouse bins removed, according to an exemplary embodiment of the present disclosure;

FIG. 7 shows the warehouse cart of FIG. 2 with the shelf lowered, according to an exemplary embodiment of the present disclosure;

FIG. shows the warehouse cart of FIG. 2 with the shelf lowered and the warehouse bins upon the shelf removed, according to an exemplary embodiment of the present disclosure;

FIG. 9 shows the warehouse cart of FIG. 2 without any warehouse bins thereupon, according to an exemplary embodiment of the present disclosure;

FIG. 10 shows a block component diagram of powered elements of a warehouse cart, according to an exemplary embodiment of the present disclosure;

FIG. 11 shows a warehouse cart with multiple powered shelves, according to an exemplary embodiment of the present disclosure;

FIG. 12 shows the warehouse cart of FIG. 11 with the upper shelf raised out of the way so that the lower shelf is in a position to be utilized, according to an exemplary embodiment of the present disclosure;

FIG. 13 shows the warehouse cart of FIG. 11 with the lower shelf lowered out of the way so that the upper shelf is in a position to be utilized, according to an exemplary embodiment of the present disclosure;

FIG. 14 shows a warehouse cart with three powered shelves, according to an exemplary embodiment of the present disclosure;

FIG. 15 shows a warehouse cart with shelves that can be folded up and back and out of the way, according to an exemplary embodiment of the present disclosure; and

FIG. 16 shows a warehouse cart having one or more scales positioned on one or more shelves, according to an exemplary embodiment of the present disclosure.

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

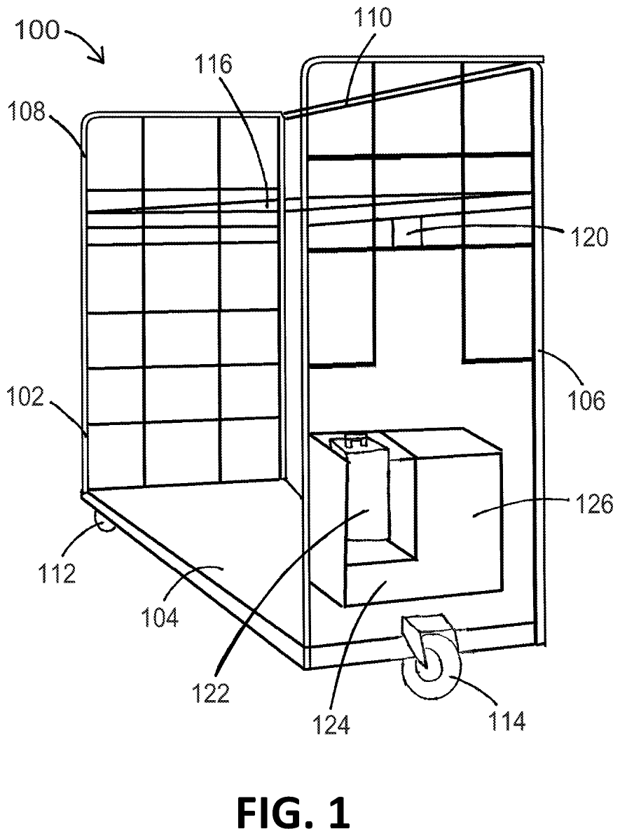

An exemplary embodiment of a warehouse cart of the present disclosure is shown in FIG. 1. As shown therein, warehouse cart 100 comprises a cart body 102 comprising a bottom 104, a first side 106, an opposite second side 108, and a back 110. Cart 100 is movable by way of one or more passive wheels, casters, or powered or unpowered all-terrain tracks (wheels) 112 as well as one or more powered wheels 114, such as shown in FIG. 1.

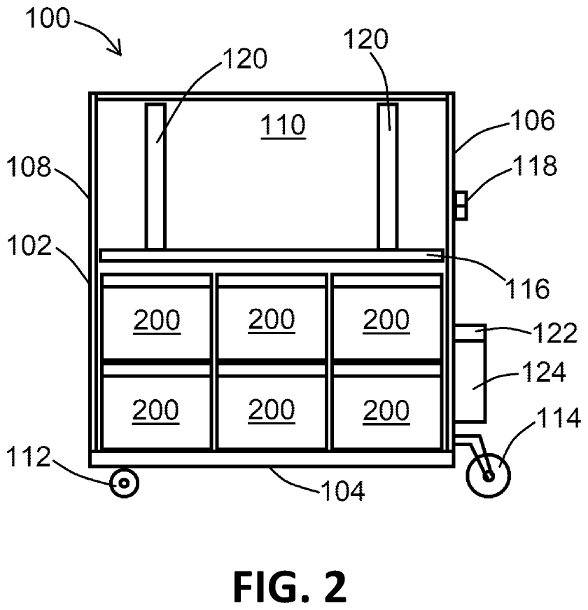

Carts 100 of the present disclosure are configured to retain a plurality of warehouse bins 200, such as shown in FIG. 2. As shown therein, warehouse bins 200 may be sized and shaped so that they can be stacked to a lowest point of powered shelf 116. Powered shelf 116 is configured to move up and down, permitting a user to position one or more warehouse bins 200 on the shelf 116, raise the shelf 116 using shelf controls 118, and when the shelf 116 is in a raised position, additional warehouse bins 200 can be stacked upon those already residing on the cart. Shelf 116 can be raised and lowered by way of shelf lift mechanism 120 coupled to said shelf 116, with shelf lift mechanism 120 operably coupled to shelf controls 118. Shelf lift mechanism 120 can be coupled to a back 110 of said cart 100, or optionally to a first side 106 and/or a second side 108 of cart 100. Shelf controls 118 can comprise one or more levers, switches, and/or buttons, for example.

Carts 100 of the present disclosure are powered via one or more removable batteries 122 docked within dock 124 (or alternatively, one or more batteries 122 that are not readily removable from said cart 100, and for which can be charged directly using external AC power, for example). Batteries 122 of the present disclosure would therefore be operatively connected to the shelf lift mechanism 120 to power the same. When a battery 122 of the present disclosure becomes depleted, it can be readily removed from dock 124 and replaced by docking a charged battery 122 in its place. Batteries 122 are used to power a motor 126 configured to power one or more powered wheels 114. Powered wheels 114 are configured so that when a user begins to move a cart 100 of the present disclosure, powered wheels 114 are operated to assist movement of said cart 100 until the user wishes to stop the cart 100 movement, which is accomplished by pulling or pushing said cart 100 in an opposite direction from the original movement, whereby powered wheels 114 are operated to stop said cart 100 using braking. In at least one embodiment, powered wheels 114 have slope resistance configurations so that when a cart 100 would move downhill it would not accelerate. In at least another embodiment, proximity sensors 900 on said cart 100 can be operated so that the cart 100, when being moved or moving, can avoid obstacles along the way so to avoid crashing.

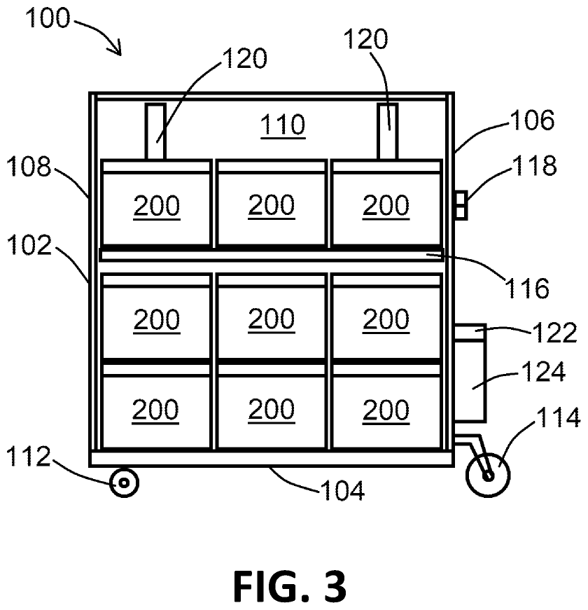

Use of an exemplary cart 100 of the present disclosure is represented via FIGS. 2 through 5. FIG. 2 shows a front view of an exemplary cart 100 of the present disclosure having six warehouse bins 200 contained therein. Shelf 116 is shown in its lowered position. In FIG. 3, three additional warehouse bins or storage containers (bins) 200 are added to cart 200, but this time upon shelf 116. In this embodiment, the height of three stacked warehouse bins 200 is the limit of safe stacking given the size and weight of full warehouse bins 200 and their relative height upon cart 100, which can be considered to be too high when too many warehouse bins 200 are stacked.

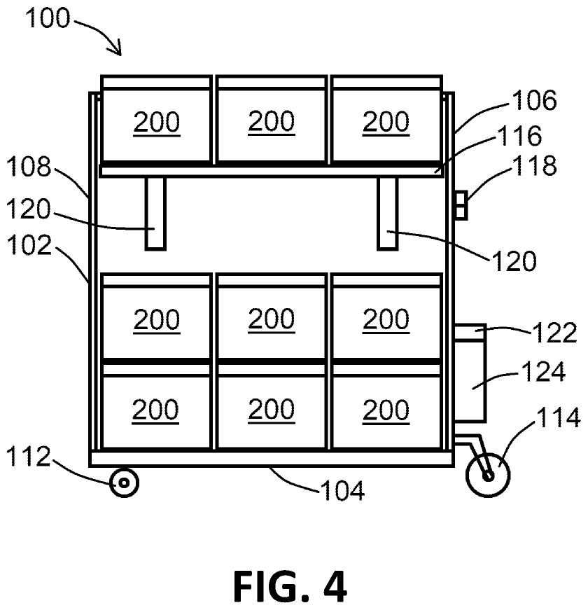

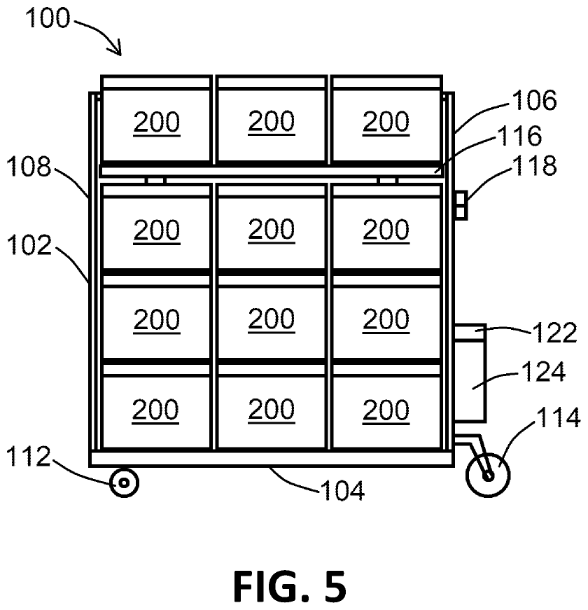

FIG. 4 shows the cart 100 of FIGS. 2 and 3, but with shelf 116 raised. Shelf 116 is raised up and down using battery 122, namely to power the shelf lift mechanism 120, which may be the same battery that is used to power the powered wheels 114 for movement of said cart 100. Raising shelf 116 causes the three warehouse bins 200 to be raised upward, making room for three additional warehouse bins 200, such as shown in FIG. 5. Such an embodiment of a cart 100 and warehouse bins 200 shows that, for example, a fourth row of bins 200 can be safely added to and transported using cart 200 without actually having to stack that fourth row of bins 200 on the fourth (top) row.

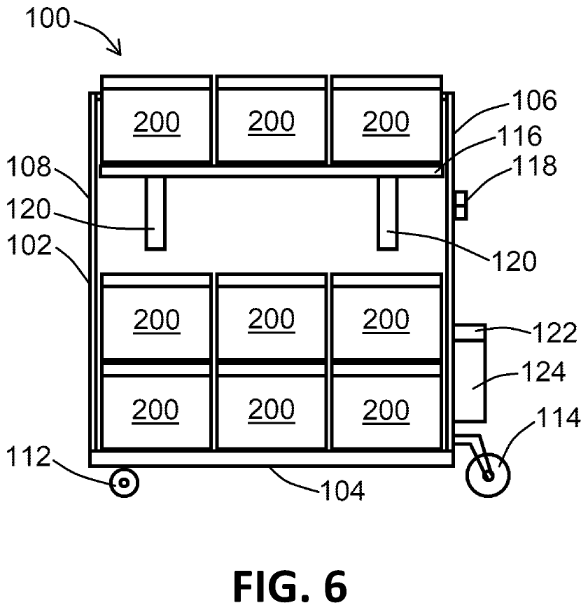

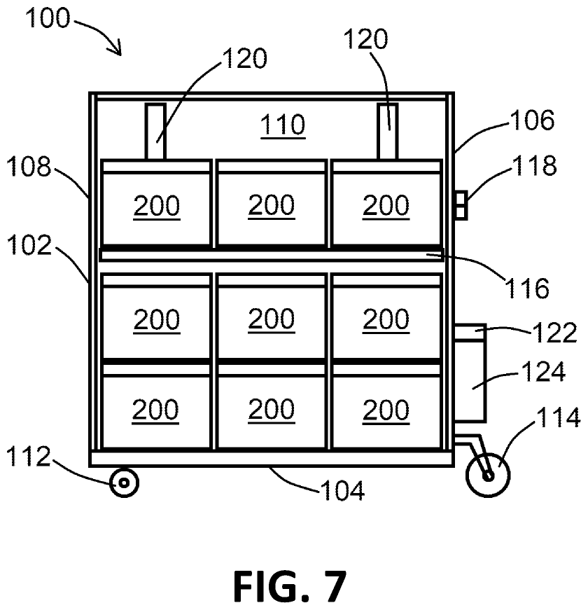

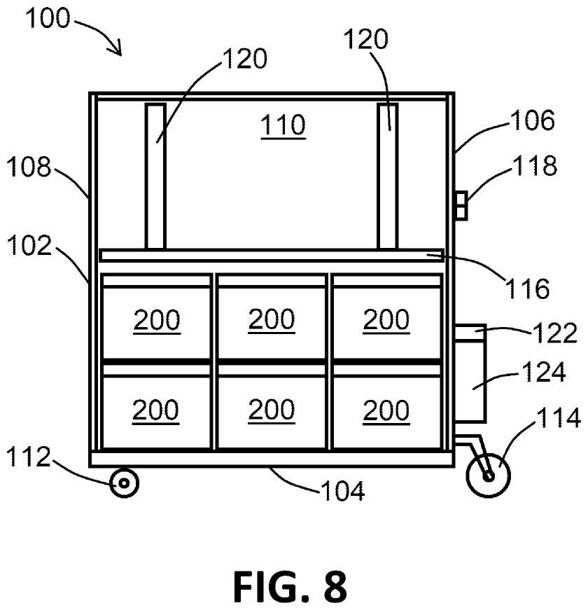

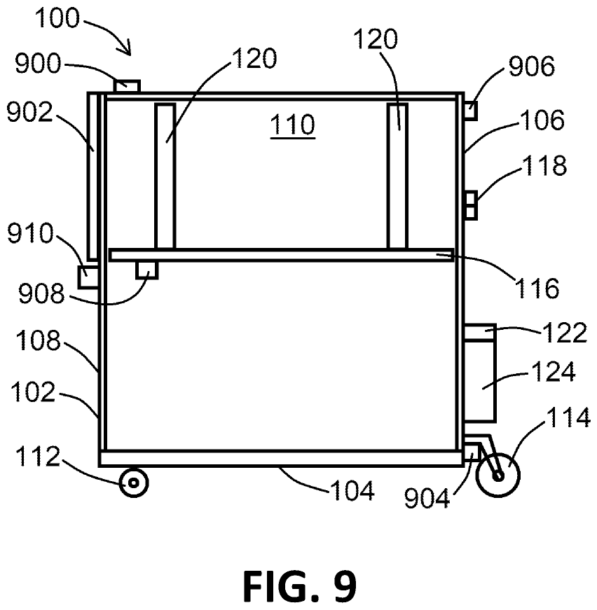

To safely remove said warehouse bins 200 after cart 100 has been moved to a desired location, a user would remove at least the three warehouse bins 200 added to said cart as shown in FIG. 6. When at least those three warehouse bins 200 are removed, such as depicted in FIG. 6, shelf 116 can be lowered to provide safe access to said warehouse bins 200 located thereupon, such as shown in FIG. 7, as said warehouse bins 200 would then be at the height of the three warehouse bins 200 that were previously removed. Said warehouse bins 200 positioned upon shelf 116 can then be safely removed, such as shown in FIG. 8. The remainder of said warehouse bins 200 can also be removed, as shown in FIG. 9.

It can be appreciated that based upon the dimensions of the warehouse bins 200 relative to said cart 100, more or fewer warehouse bins 200 could be placed upon said cart 100 below shelf 116, and more or fewer warehouse bins 200 could be placed upon said shelf 116.

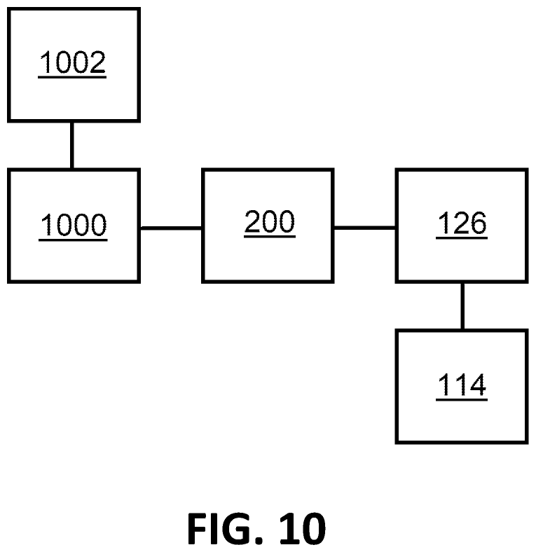

It can further be appreciated that warehouse carts 100 of the present disclosure could be autonomous, meaning that when a cart 100 has a desired number of bins 200 or other items positioned thereon, cart 100 can move to a different location automatically, such as by way of a central processing unit 1000 operably connected to powered wheel 114. Central processing unit 1000 can be operably coupled to a location mechanism 1002, such as shown in the block diagram of FIG. 10, such that central processing unit 1000 instructs motor 126 to operate to operate powered wheel 114 to move the cart 100 to a desired location, such as by way of operating location mechanism 1002, such as a global positioning system (GPS) unit or a local positioning system within a warehouse, for example.

In at least one embodiment, carts 100 of the present disclosure can further comprise a shroud 902, such as shown in FIG. 9, positioned on either side 106, 108, and/or on back 110, of said cart near the powered shelf 116 or attached to the shelf 116 itself so to prevent a user from injuring their hand or fingers while shelf 116 moves up and down. Shroud 902 can comprise any number of materials, such as plastic (like Plexiglas), netting, or another rigid material.

Various cart 100 embodiments of the present disclosure may further comprise or utilize one or more additional safety features, such as automatic cart 100 braking when a user lets go of the control/cart 100 (such as by way of operation of motor 126 and/or a brake mechanism 904 in communication with powered wheel 114. An emergency stop button 906, such as shown in FIG. 9, used to stop powered shelf 116 from moving up or down and/or to stop cart 100 itself from moving. One or more sensors 908 can be used in connection with powered shelf 116 to prevent injury, such as a sensor 908 that can detect a user's arm or hand beneath said shelf 116, that can detect one or more bins 200 positioned below said shelf 116 (so not to contact or crush said bins 200), and/or to contact one or more items/elements above said shelf 116, such as a warehouse rack, a doorjamb, a light, a fire suppression element, and the like. Sensors 908 can also be used to cause powered shelf 116 to stop moving before crushing an object, like one or more bins 200 positioned below powered shelf 116 or a person or a person's body part positioned below powered shelf 116. Said sensors 908 can be software controlled whereby the sensor communicates resistance and stops the shelf lift mechanism 120, or that said sensors 908 act as pressure sensors located under powered shelf 116 so that when someone or something touches sensor 908, it will stop powered shelf 116 from moving.

Carts 100 of the present disclosure, in various embodiments, can be controlled by way of a cart controller 910, such as a joystick, a group of buttons, a dial, etc. In at least some embodiments, cart controller 910 is configured to permit a user to direct the cart forward, backwards, optionally sideways, and in some embodiments, when the controller 910 is not operated, such as when the controller 910 is “let go” by the user, cart 100 would come to a stop.

The present disclosure includes disclosure of carts 100, whether original or retrofitted, having one or more components and/or features as disclosed herein. Systems of the present disclosure can be considered as having or not having cart 100, but having other components and/or features as described herein.

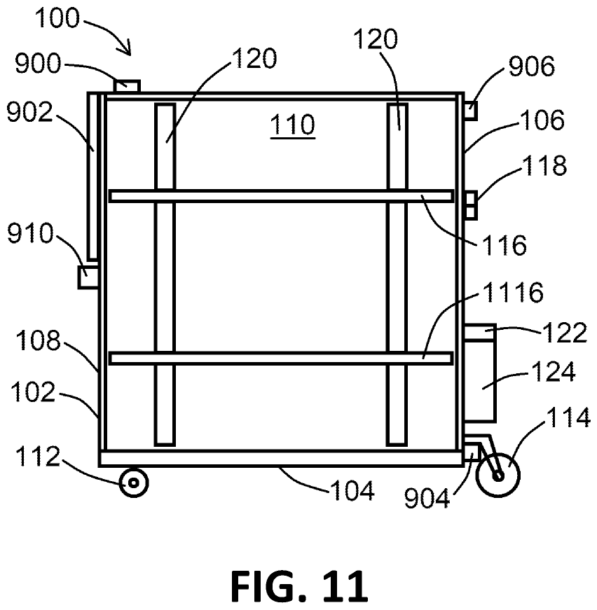

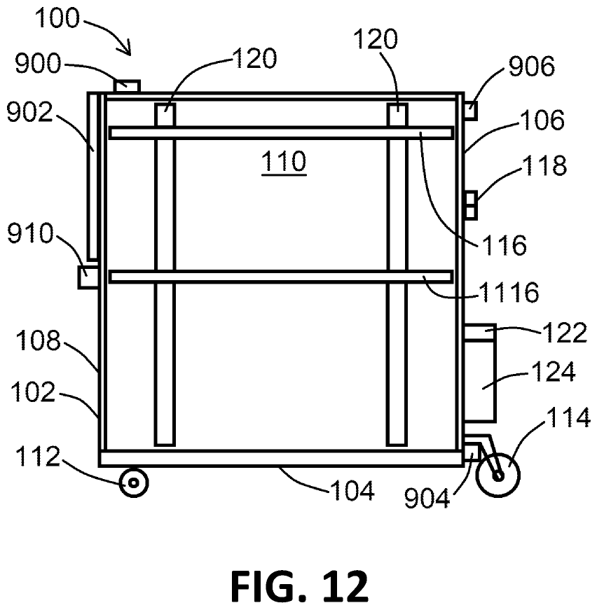

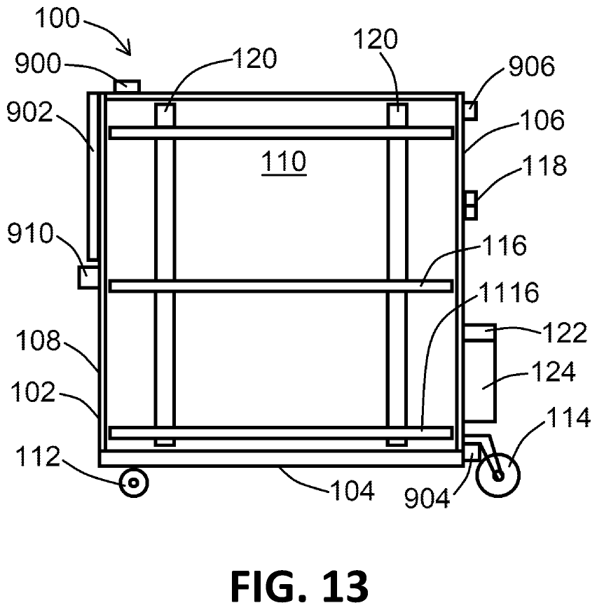

Additional cart 100 embodiments are shown in FIGS. 11, 12, and 13. As shown therein, exemplary carts 100 of the present disclosure can comprise a plurality of powered shelves, such as powered shelf 116 (here, the relatively upper shelf) and powered shelf 1116 (here, the relatively lower shelf). FIG. 11 shows shelves 116, 1116 in a relatively neutral position for transport, whereby shelves 116, 1116 are positioned in a relative middle area of cart 100. FIG. 12 shows the embodiment of cart 100 of FIG. 11, but in a configuration for loading the relatively lower shelf (shelf 1116), whereby shelf 1116 is in a relative middle of cart 100 and whereby shelf 116 is fully or mostly raised up and out of the way. FIG. 13 shows the embodiment of cart 100 of FIGS. 11 and 12, whereby shelf 116 is in a relative middle of cart 100 and whereby shelf 1126 is fully or mostly lowered down and out of the way.

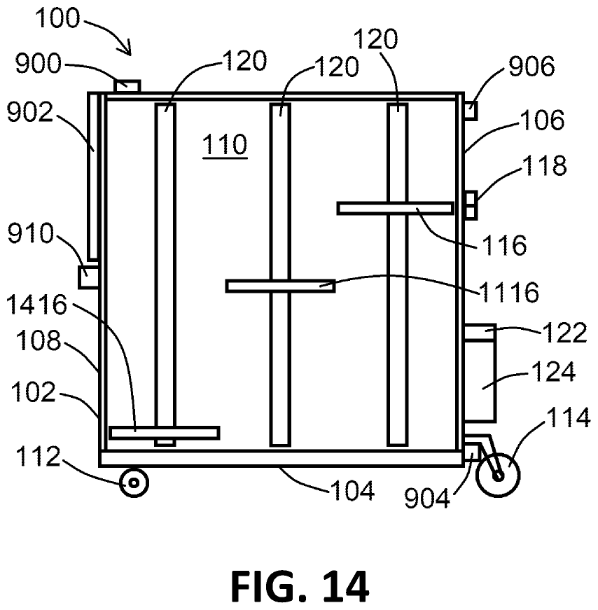

An additional cart 100 embodiment of the present disclosure is shown in FIG. 14. As shown therein, cart 100 comprises three powered shelves, such as shelf 116, 1116, and 1416. In such an embodiment, each shelf 116, 1116, 1416 can move independently of the other, such as by way of operating of one or more shelf controls 118, which can be wired to or in wireless communication with cart 100. In such an embodiment, the “split” shelves 116, 1116, 1416 provide more flexibility and usability when loading and/or transporting large or bulky items and provides greater safety in the event that a user were to hit a shelf with an external object or body part. Embodiments of carts 100 of the present disclosure with one, two, three, four, or more powered shelves 116, 1116, 1416, etc., are contemplated herein.

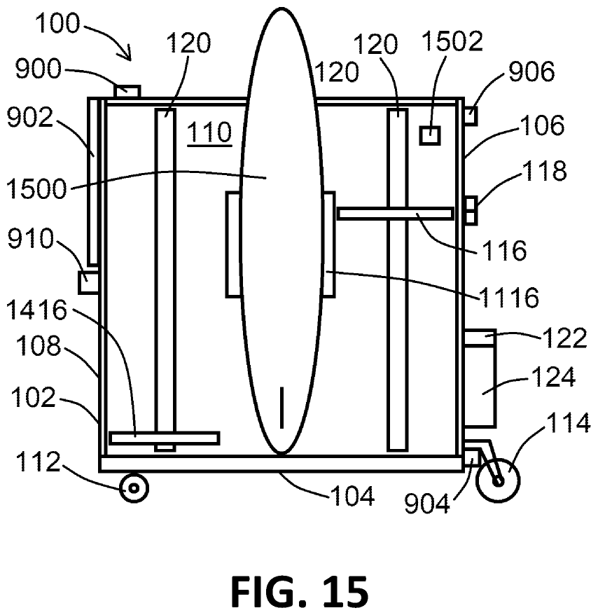

FIG. 15 shows an embodiment of a cart 100 of the present disclosure, whereby one or more of the powered shelves 116, 1116, 1416 can be folded up and back so to allow for larger items 1500 to be positioned upon said cart 100. A surfboard (an exemplary larger item 1500) is shown in FIG. 15, positioned upon cart 100 while shelf 1116 is folded up and back and out of the way. Shelf 1116 (or 116 or 1416), when folded up and back, can be held in place using a shelf mechanism 1502, such as a magnet, a clip, a latch, a knob, etc., so that it does not unintentionally fall back into place. In at least one embodiment of the present disclosure, shelves 116, 1116, 1416 can be removed from cart 100 and replaced as may be desired.

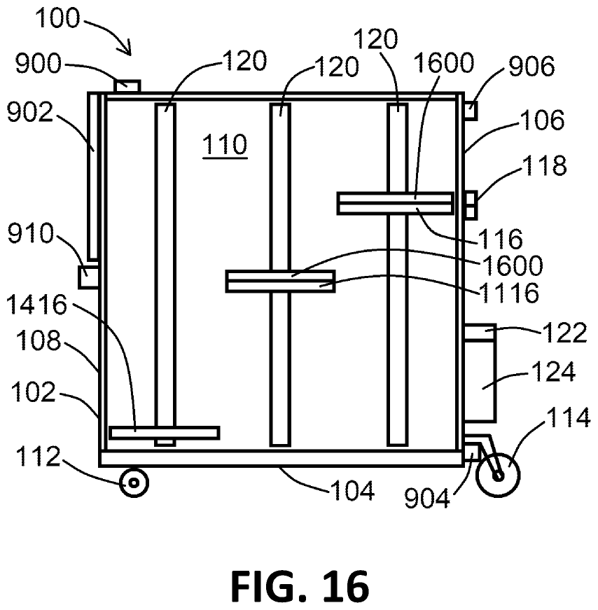

FIG. 16 shows a cart 100 embodiment whereby one or more shelves (shelves 116, 1116, 1416) have a scale 1600 thereon or integrated therein. Said scales 1600 can independently display the weights of the items on each shelf 116, 1116, 1416, and/or can display the collective weight of all items on the cart 100, such as if one or more scales 1600 is used upon or integrated into the relative bottom 104 of cart 100. In at least one embodiment, and if the cart 100 is under-weight or over-weight, the powered wheel 114 would not permit the cart 100 to be moved, as may be desired.

Elements of carts 100 of the present disclosure can be provided as a kit. For example, a kit of the present disclosure can comprise a first shelf 116, a first shelf lift mechanism 120, and a battery 122. The warehouse cart 100 can then be assembled by providing the kit and assembling the warehouse cart 100 by coupling said elements of the kit to the cart body 102. An exemplary kit of the present disclosure may comprise a first shelf 116, a first shelf lift mechanism 120, a second shelf 1116, a second shelf lift mechanism 120, and a battery 122. The warehouse cart 100 can then be assembled by providing the kit and assembling the warehouse cart 100 by coupling said elements of the kit to the cart body 102.

Warehouse carts 100 of the present disclosure can be used, for example, by placing one or more bins 200 upon a first shelf 116 of the warehouse cart 100, operating the shelf lift mechanism 120 to lift the first shelf 116 to an upper position, and placing one or more additional bins 200 upon the bottom 104 of the cart body 102 of the warehouse cart 100.

While various embodiments of powered warehouse carts and methods of using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A warehouse cart, comprising:
a cart body having a bottom, a first side, an opposite second side, and a back;
a first shelf coupled to a shelf lift mechanism coupled to or positioned relative to the cart body; and
a battery is configured to provide power to the shelf lift mechanism to move the first shelf up and down.

2. The warehouse cart of claim 1, further comprising:
a powered wheel coupled to the cart body, the powered wheel having a motor or having a motor coupled thereto.

3. The warehouse cart of claim 2, wherein the battery is configured to provide power to the motor to operate the powered wheel to facilitate powered movement of the cart.

4. The warehouse of cart 2, wherein when the cart is initially pushed or pulled in a first direction, the powered wheel operates to assist movement of the cart, and wherein when the cart is then pushed or pulled in an opposite, second direction, the powered wheel stops operating.

5. The warehouse cart of claim 2, wherein the powered wheel has a slope resistance configuration so that the cart will not accelerate downhill when the powered wheel is in operation.

6. The warehouse cart of claim 1, further comprising:
one or more passive wheels or casters coupled to the cart body.

7. The warehouse cart of claim 1, further comprising:
one or more shelf controls configured to control movement of the first shelf up and down.

8. The warehouse cart of claim 1, wherein one or more warehouse bins can be positioned upon the first shelf and be moved up and down with the first shelf by way of the shelf lift mechanism.

9. The warehouse cart of claim 1, further comprising:
a battery dock configured to retain the battery.

10. The warehouse cart of claim 9, wherein when the battery has a depleted charge, the battery can be removed from the dock and be replaced with a charged second battery.

11. The warehouse cart of claim 1, wherein the battery can be charged using external AC power.

12. The warehouse cart of claim 1, further comprising:
proximity sensors configured so that the cart can avoid obstacles while it is being moved.

13. The warehouse cart of claim 1, wherein the first shelf is configured to move to a lowest position that is above a warehouse bin positioned upon the bottom of the cart body.

14. The warehouse cart of claim 1, wherein the first shelf is configured to move to a lowest position that is above two stacked warehouse bins positioned upon the bottom of the cart body.

15. The warehouse cart of claim 14, wherein when an additional warehouse bin is positioned upon the first shelf, the first shelf can operate to move upward, creating a space below the first shelf and above the two stacked warehouse bins so that a third bin can be stacked upon the two stacked warehouse bins.

16. The warehouse cart of claim 1, further comprising:
a first scale positioned upon the first shelf, the first scale configured to weigh one or more items positioned thereupon.

17. The warehouse cart of claim 1, further comprising:
a second shelf positioned above the first shelf, the second shelf coupled to the shelf lift mechanism, wherein the shelf lift mechanism can be operated to move the second shelf up and down.

18. The warehouse cart of claim 17, further comprising:
a first scale positioned upon the first shelf, the first scale configured to weigh one or more items positioned thereupon; and
a second scale positioned upon the first shelf, the second scale configured to weigh one or more items positioned thereupon.

19. The warehouse cart of claim 17, further comprising:
a third shelf positioned below the first shelf, the second shelf coupled to the shelf lift mechanism, wherein the shelf lift mechanism can be operated to move the third shelf up and down.

20. The warehouse cart of claim 19, further comprising:
a first scale positioned upon the first shelf, the first scale configured to weigh one or more items positioned thereupon;
a second scale positioned upon the first shelf, the second scale configured to weigh one or more items positioned thereupon; and
a third scale positioned upon the third shelf, the third scale configured to weigh one or more items positioned thereupon.

21. The warehouse cart of claim 1, further comprising:
a second shelf coupled to a second shelf lift mechanism, wherein the second shelf lift mechanism can operate to move the second shelf independent of movement of the first shelf.

22. The warehouse cart of claim 21, further comprising:
a first scale positioned upon the first shelf, the first scale configured to weigh one or more items positioned thereupon; and
a second scale positioned upon the first shelf, the second scale configured to weigh one or more items positioned thereupon.

23. The warehouse cart of claim 21, further comprising:
a third shelf coupled to a third shelf lift mechanism, wherein the third shelf lift mechanism can operate to move the third shelf independent of movement of the first shelf and the second shelf.

24. The warehouse cart of claim 23, further comprising:
a first scale positioned upon the first shelf, the first scale configured to weigh one or more items positioned thereupon;
a second scale positioned upon the first shelf, the second scale configured to weigh one or more items positioned thereupon; and
a third scale positioned upon the third shelf, the third scale configured to weigh one or more items positioned thereupon.

25. The warehouse cart of claim 1, further comprising:
a powered wheel coupled to the cart body;
a motor coupled to the powered wheel; and
a central processing unit operably coupled to the motor and configured to instruct the motor to operate the powered wheel to move the cart.

26. The warehouse cart of claim 1, further comprising:
a location mechanism coupled to the central processing unit, the location mechanism configured to facilitate movement of the cart to a desired location.

27. The warehouse cart of claim 1, further comprising:
a shroud configured to be positioned relative to the first shelf and configured to prevent a user from injuring their hand or fingers while the first shelf moves up and down.

28. The warehouse cart of claim 1, further comprising:
a cart controller configured to direct movement of the cart when operated by a user.

29. The warehouse cart of claim 1, assembled by:
providing a kit to an existing cart, the kit comprising the first shelf, the shelf lift mechanism, and the battery; and
assembling the warehouse cart by coupling elements of the kit to the cart.

30. The warehouse cart of claim 1, further comprising:
a second shelf, the second shelf movable up and down using the shelf lift mechanism or a second shelf lift mechanism.

31. The warehouse cart of claim 30, assembled by:
providing a kit to an existing cart, the kit comprising the first shelf, the shelf lift mechanism, the second shelf, the second shelf lift mechanism, and the battery; and
assembling the warehouse cart by coupling elements of the kit to the cart.

32. The warehouse cart of claim 1, further comprising:
a sensor positioned relative to the first shelf, the sensor configured to alert a user to an obstacle above or below the shelf when the first shelf is moving up or down.

33. A method of using a warehouse cart, comprising the steps of:
placing one or more bins upon the first shelf of the warehouse cart of claim 1;
operating the shelf lift mechanism to lift the first shelf to an upper position; and
placing one or more additional bins upon the bottom of the cart body of the warehouse cart.
